(19) United States
(12) Patent Application Publication
(10) Pub. No.: US 2013/0181600 A1
(43) Pub. Date: Jul. 18, 2013

(54) INNER COUPLING ELECTRODELESS LAMP

(71) Applicants: Wenjun Chen, West Govina, CA (US); Heping Chen, Nanping (CN); Hequan Zhang, Nanping (CN); Liwu Luo, Nanping (CN)

(72) Inventors: Wenjun Chen, West Govina, CA (US); Heping Chen, Nanping (CN); Hequan Zhang, Nanping (CN); Liwu Luo, Nanping (CN)

(21) Appl. No.: 12/993,830

(22) PCT Filed: Sep. 9, 2010
(86) PCT No.: PCT/CN2010/076747

§ 371 Date: Nov. 19, 2010

(51) Int. Cl. H01J 61/02

(52) U.S. Cl. CPC H01J 61/025
USPC 313/490

(57) ABSTRACT

An inner coupling electrodeless lamp comprises a glass bulb and a power coupler. A cold end of the glass bulb is provided with an amalgam. The glass bulb includes an external portion and an inner portion. A gas discharging cavity that is annularly airtight is defined by the envelopment of the external portion and the inner portion. The gas discharging cavity is full of inert gas. A coupling cavity is defined in the inner portion. The power coupler includes a radiating post, a ferrite core, and a winding sequentially situating from an interior to an exterior thereof. The power coupler is disposed in the coupling cavity. At least one diffuse reflection layer that is made of a material falling in a 250˜2000 nm spectrum scope and containing a high diffuse reflection rate larger than 30% is disposed between an inner wall of the inner portion and an external surface of the coupler. The material for making the diffuse reflection layer adopts a non-conducting electricity material that resists a high temperature higher than 100° C. The diffuse reflection layer reflects the visible light and the ultrared ray back to the annularly airtight gas discharging cavity, so that the visible light and the ultrared ray are leaked out of the external surface of the glass bulb. Thereby, the original visible light unable to be used becomes usable, so that the illuminant efficiency is promoted, the operating temperature is decreased, and the using life is extended.

### BACKGROUND OF THE INVENTION

1. Field of the Invention

The present invention relates to an electrodeless fluorescent lamp, in particularly to an inner coupling electrodeless lamp.

2. Description of the Related Art

The electrodeless fluorescent lamp is also called the electrodeless lamp. Such lamp could be classified into two types in accordance with the structures and the means for power coupling. One of the classifications is the electrodeless fluorescent lamp with the tubular annular external power coupling, and the other of the classifications is the inner coupling electrodeless lamp with the globe type. The radiating means of the inner coupling electrodeless lamp with the globe type is as follows: A high frequency generator provides the high-frequency electricity to a power coupler disposed inside the globe. A discharging cavity of the power coupler in the bulb creates an electromagnetic field, so that the inert gas within the discharging cavity could be ionized and thereby emits the ultraviolet. As a result, the fluorescent powder on an inner wall of the globe is thence excited by the ultraviolet so as to emit the visible light.

Referring to FIG. 1, the existing electrodeless fluorescent lamp with the globe inner coupling has a globe body 1. Such lamp usually comprises a globe glass bulb 11, an amalgam (not shown), a power coupler 12, and a radiating post 13. A radiating lid 14 is disposed on an external end of the radiating post 13. An external portion 111 and an inner portion 112 included by the glass bulb 11 further encompass a gas discharging cavity 15 that is annularly airtight. A coupling cavity 16 is defined in the inner portion 112. The power coupler 12 is disposed on an external surface of the radiating post 13; the power coupler 12 is thence disposed within the coupling cavity 16 of the inner portion 112 along with the radiating post 13. The power coupler 12 further includes a ferrite core 121 that is superimposed on the external surface of the radiating post 13 and a winding 122 that is wound around an external surface of the ferrite core 121.

During the radiation of afore fluorescent lamp, partial visible light and ultrared ray penetrated from the gas discharging cavity 15 are directly cast on the winding 122 of the power coupler 12 and on the external surfaces of partial ferrite core 121 and the radiating post 13. Thereby, the visible light and the ultrared ray are thence absorbed on the external surfaces of the partial ferrite core 121 and the radiating post 13. Disadvantages like the decreased illuminant efficiency of the globe body 1 and the increased temperature existing in the entire coupling cavity 16 of the inner portion 112 are adversely incurred. As a result, the performance of the power coupler 12 is influenced. Even worse, the ultraviolet in the fluorescent powder further damages the power coupler 12, so that the using life of the power coupler 12 is affected.

### SUMMARY OF THE INVENTION

The object of the present invention is to provide an inner coupling electrodeless lamp. A reflection layer reflects the visible light and the ultrared ray back to a gas discharging cavity. Thereby, the visible light and the ultrared ray are emitted from an external surface of a glass bulb, so that the illuminant efficiency is enhanced, the operating temperature is decreased, and the using life is prolonged.

The present invention is achieved by the following techniques: An inner coupling electrodeless lamp comprises a glass bulb and a power coupler. A cold end of the glass bulb is provided with an amalgam. The glass bulb includes an external portion and an inner portion. A gas discharging cavity that is annularly airtight is defined by the envelopment of the external portion and the inner portion. The gas discharging cavity is full of inert gas. A coupling cavity is defined in the inner portion. The power coupler includes a radiating post, a ferrite core, and a winding sequentially situating from an interior to an exterior thereof. The power coupler is disposed in the coupling cavity. Characterized in that, at least one diffuse reflection layer that is made of a material falling in a 250˜2000 nm spectrum scope and containing a high diffuse reflection rate larger than 30% is disposed between an inner wall of the inner portion and an external surface of the coupler. Wherein, the material for making the diffuse reflection layer adopts a non-conducting electricity material that resists a high temperature higher than 100° C.

The diffuse reflection layer adopts the F4, PTFE, TEFLON or other material that resists a high temperature and contains a high diffuse reflection rate.

The diffuse reflection layer covers the inner wall of the inner portion or covers the external surface of the power coupler, or the reflection layer is alternatively disposed at any place inside the inner portion or at any place on the external surface of the power coupler.

A thickness of the diffuse reflection layer is measured from 0.01 to 5 mm.

Advantages of the present invention lie in: By means of the diffuse reflection layer that is made of a material falling in a 250˜2000 nm spectrum scope and containing a high diffuse reflection rate larger than 30% being disposed between an inner wall of the inner portion and an external surface of the coupler, and by means of the material for making the diffuse reflection layer adopting the non-conducting electricity feature that is able to resist a high temperature higher than 100°C., the visible light and the ultrared ray leaked from the gas discharging cavity out of the coupling cavity are preferably reflected back to the gas discharging cavity. As a result, the visible light and the ultrared ray penetrate the external surface of the glass bulb, rather than being directly cast on the external surface of the power coupler formed by the power coupler and the radiating post. Thus, the illuminant efficiency is enhanced, the operating temperature is decreased, and the using life is prolonged.

### BRIEF DESCRIPTION OF THE DRAWINGS

FIG. 1 is an axially cross-sectional view showing a conventional electrodeless fluorescent lamp with the globe inner coupling;

FIG. 2 is an axially cross-sectional view showing a first preferred embodiment of the present invention;

FIG. 3 is an axially cross-sectional view showing a second preferred embodiment of the present invention; and

FIG. 4 is an axially cross-sectional view showing a third preferred embodiment of the present invention.

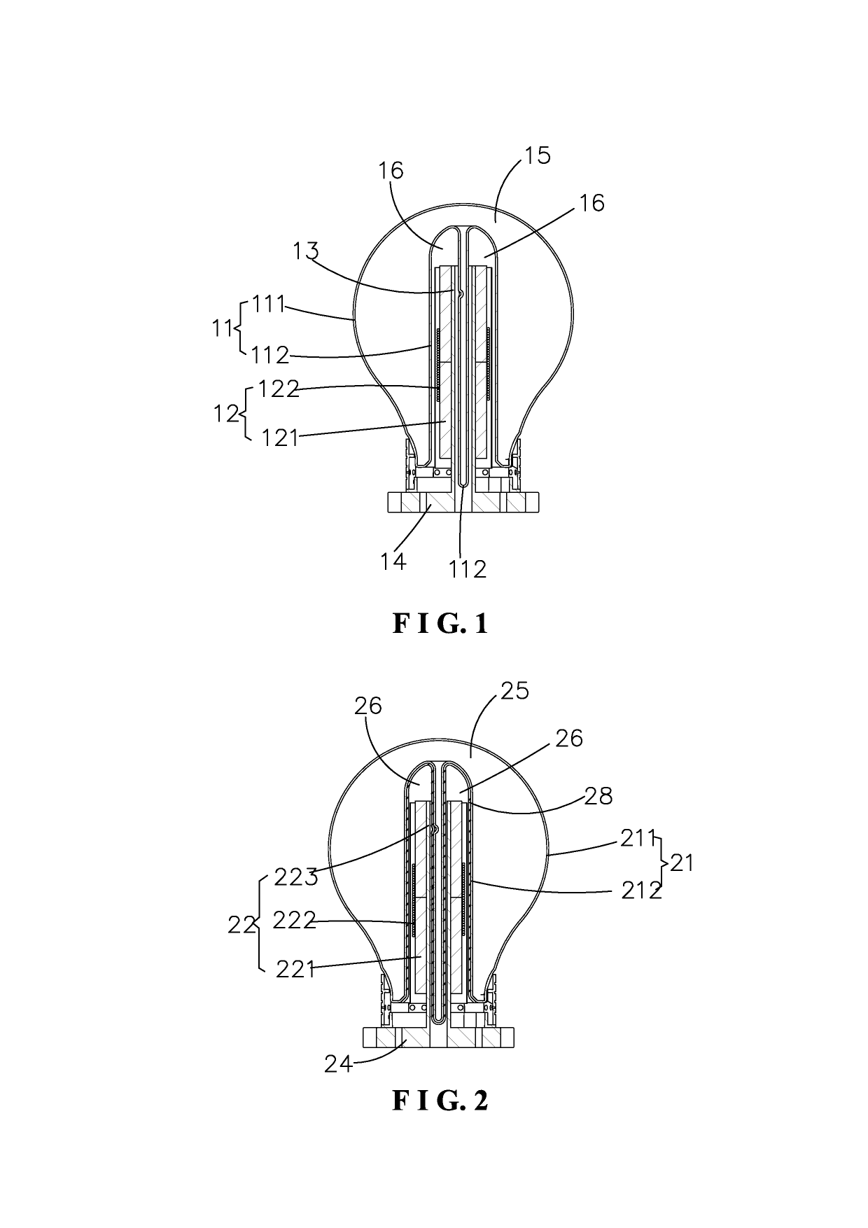

### DETAILED DESCRIPTION OF THE PREFERRED EMBODIMENTS

### First Preferred Embodiment

Referring to FIG. 2, the inner coupling electrodeless lamp 2 is directed to the inner coupling electrodeless lamp with the globe type. Such lamp comprises a glass bulb 21 and a power coupler 22. A cold end of the glass bulb 21 is provided with an amalgam (not shown). The glass bulb 21 includes an external portion 211 and an inner portion 212. A gas discharging cavity 25 that is annularly airtight is defined by the envelopment of the external portion 211 and the inner portion 222. A coupling cavity 26 is defined in the inner portion 212. The power coupler 22 includes a radiating post 223, a ferrite core 221, and a winding 222 sequentially situating from an interior to an exterior thereof. The ferrite core 221 is superimposed on the external surface of the radiating post 223 and a winding 222 is wound around an external surface of the ferrite core 221. A radiating lid 24 is further disposed on an external end of the radiating post 223. The power coupler 22 is disposed in the coupling cavity 26 of the inner portion 212.

A reflection layer 28 covers the inner wall of the inner portion 212. Wherein, the reflection layer 28 adopts the F4, PTFE, TEFLON whose thickness is measured from 0.01 to 5 mm.

In the covering operation, the F4, PTFE, TEFLON is formed into a film. Accordingly, the film is evenly pasted on the inner wall of the inner portion 212 to form the reflection layer 28. In fact, the F4, PTFE, TEFLON could be alternatively formed into the cream state. Accordingly, the inner wall of the inner portion 212 could be coated with the cream so as to form the reflection layer 28.

Herein, the diffuse reflection rate of the F4, PTFE, TEFLON is rather high while existing in the spectrum scope falling in 250 to 2500 nm. Moreover, the spectrum of reflection is flat and preferably resists a high temperature (higher than 250 degrees centigrade), so such features are suited to the electrodeless fluorescent lamp. Accordingly, in radiating the electrodeless fluorescent lamp in this embodiment, partial visible light and ultrared ray going toward the coupling cavity 26 from the gas discharging cavity 25 are reflected back to the gas discharging cavity 25 in view of the resistance of the reflection layer 28. Thereby, the visible light and the ultrared ray are leaked from the external surface of the glass bulb, rather than being directly cast and absorbed on the external surface of the power coupler 22. Consequently, the illuminant efficiency of the lamp body 2 is enhanced, and the operating temperature in the coupling cavity 26 of the inner portion 212 is decreased. Preferably, the integral performance of the power coupler 22 would not be affected, and the ultraviolet does not damage the power coupler 22, either. Therefore, the using life of the present invention is promoted.

### Second Preferred Embodiment

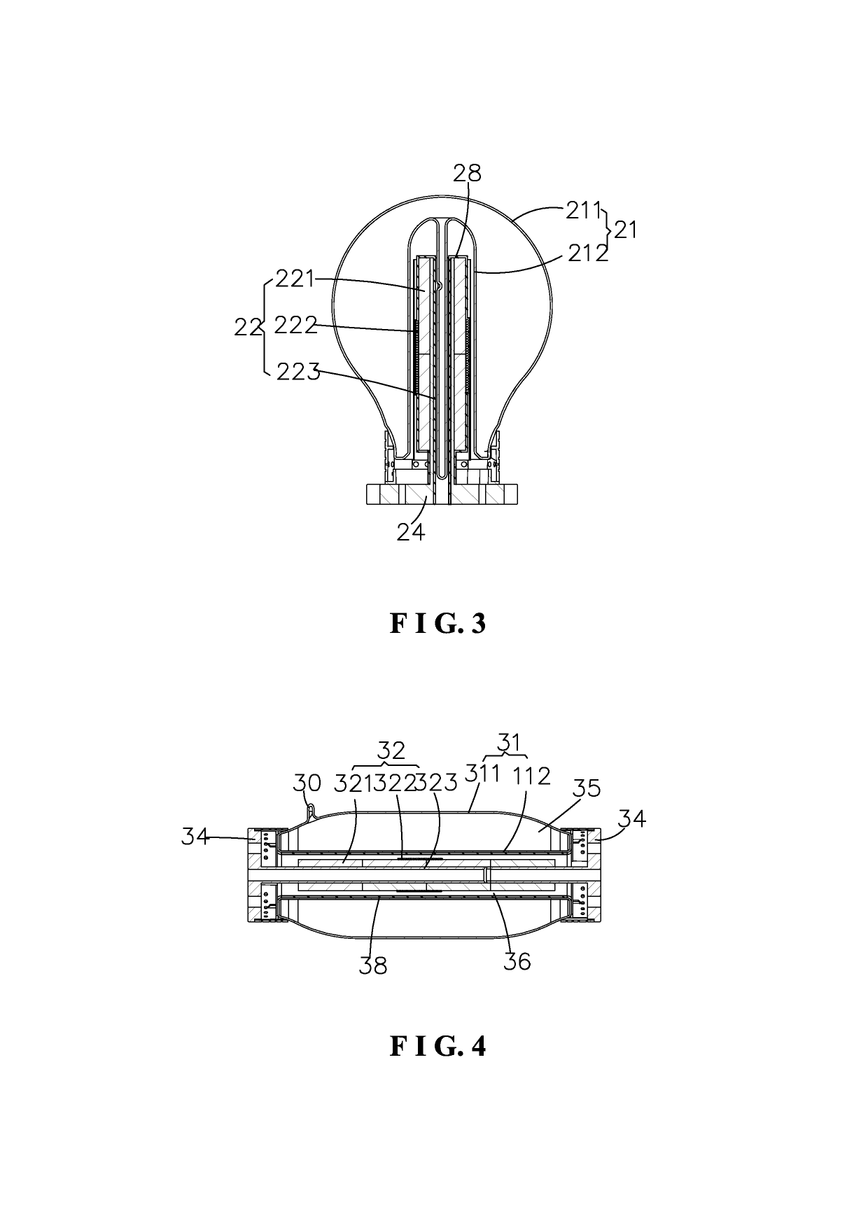

Referring to FIG. 3, the like marks same as those in the First Preferred Embodiment are correlated. The inner coupling electrodeless lamp 2 in this embodiment adopts the reflection layer 28 to cover the external surface of the power coupler 22. Other structures are same as those in the First Preferred Embodiment.

In the covering operation, the F4, PTFE, TEFLON is formed into a film. Accordingly, the film evenly covers the external surface of the power coupler 22 to form the reflection layer 28. In fact, the F4, PTFE, TEFLON could be alternatively formed into the cream state. Accordingly, the external surface of the power coupler 22 could be coated with the cream so as to form the reflection layer 28. Thereby, the favorable efficiency similar to that in the First Preferred Embodiment could be also achieved.

### Third Preferred Embodiment

Referring to FIG. 4, the electrodeless fluorescent lamp 3 in this embodiment adopts an open inner coupling electrodeless lamp. The lamp in this embodiment includes a glass bulb 31 whose two ends thereof are designed open. Herein, the middle of the glass bulb 31 is designed by a straight tube and the two ends of the glass bulb are designed by an arc shape. As it should be, the contour of the glass bulb is not limited in this embodiment since either a gourdshaped glass bulb or a straight-tube glass bulb is acceptable. The lamp in this embodiment further comprises an amalgam 30 and a power coupler 32. A gas discharging cavity 35 that is annularly airtight is defined by the envelopment of the external portion 311 and the inner portion 312. A coupling cavity 36 is defined in the inner portion 312. The power coupler 32 is installed in the coupling cavity 36. The power coupler 32 includes a radiating post 323, a ferrite core 321, and a winding 322 sequentially situating from an interior to an exterior thereof. The ferrite core 321 is superimposed on the external surface of the radiating post 33, and the winding 322 is entwined around the external surface of the ferrite core 321. Moreover, a radiating lid 34 is further disposed on an external end of the radiating post 323.

A reflection layer 38 covers the inner wall of the inner portion 312. As it should be, like the feature in the second preferred embodiment, the reflection layer 38 could alternatively cover the external surface of the power coupler 32, so the similar operation is not shown by the figure. Wherein, the reflection layer 38 adopts the F4, PTFE, TEFLON whose thickness is measured from 0.01 to 5 mm.

In the covering operation, the F4, PTFE, TEFLON is formed into a film. Accordingly, the film is evenly pasted on the inner wall of the inner portion 312 to form the reflection layer 38. In fact, the F4, PTFE, TEFLON could be alternatively formed into the cream state. Accordingly, the inner wall of the inner portion 312 could be coated with the cream so as to form the reflection layer 38.

Herein, since the two ends of the glass bulb 31 are designed open, the radiating efficiency is accordingly promoted. Further, the distance between the power coupler 32 and the external portion 311 of the glass bulb 31 is rather close, so the illuminant efficiency is thereby enhanced although the light leaking rate is also high. That is to say, the visible light and the ultrared ray leaked from the gas discharging cavity 35 toward the power coupler 32 are increase. Thus, the disposition of the reflection layer 38 of such open inner coupling electrodeless lamp should be more carefully designed.

In addition, afore preferred embodiments adopt the F4, PTFE, TEFLON to serve as the diffuse reflection layer. Preferably, other non-conducting electricity material that resists a high temperature and contains a high diffuse reflection rate is also suitable. Moreover, in the present invention, the diffuse reflection layer covers the inner wall of the inner portion or covers the external surface of the power coupler. Additionally, the reflection layer could be alternatively disposed at any place inside the inner portion or at any place on the external surface of the power coupler. Any disposition manner of the reflection layer would be suitable under the condition that the light between the inner wall of the inner portion and the external surface of the coupler is obstructed. For example, a material for the diffuse reflection containing a high reflection rate is formed into a sleeve. The sleeve is superimposed in the coupling cavity out of the power coupler, so that a diffuse reflection layer is formed. Preferably, the diffuse reflection layer could be alternatively disposed by single layer, double layers, or multiple layers.

I claim:

1. An inner coupling electrodeless lamp comprising a glass bulb and a power coupler; a cold end of said glass bulb being provided with an amalgam; said glass bulb including an external portion and an inner portion; a gas discharging cavity that is annularly airtight being defined by the envelopment of said external portion and said inner portion; said gas discharging cavity being full of inert gas; a coupling cavity being defined in said inner portion; said power coupler including a radiating post, a ferrite core, and a winding sequentially situating from an interior to an exterior thereof; said power coupler being disposed in said coupling cavity; characterized in that at least one diffuse reflection layer that is made of a material falling in a 250˜2000 nm spectrum scope and containing a high diffuse reflection rate larger than 30% is disposed between an inner wall of said inner portion and an external surface of said power coupler; wherein, said material for making said diffuse reflection layer adopts a non-conducting electricity material that resists a high temperature higher than 100° C.

2. The lamp as claimed in claim 1, wherein, said diffuse reflection layer adopts the F4, PTFE, TEFLON.

3. The lamp as claimed in claim 1 or 2, wherein, said diffuse reflection layer covers said inner wall of said inner portion or covers said external surface of said power coupler, or said reflection layer is alternatively disposed at any place inside said inner portion or at any place on said external surface of said power coupler.

4. The lamp as claimed in claim 3, wherein, a thickness of said diffuse reflection layer is measured from 0.01 to 5 mm.
